(19) United States
(12) Patent Application Publication
(10) Pub. No.: US 2025/0381869 A1
(43) Pub. Date: Dec. 18, 2025

(54) SYSTEMS AND METHODS FOR ELECTRIC VEHICLE ORGANIZATION AT ELECTRIC VEHICLE CHARGE POINTS

(71) Applicant: HERE GLOBAL B.V., EINDHOVEN (NL)

(72) Inventor: Jeffrey R. Moisan, Chicago, IL (US)

(73) Assignee: HERE GLOBAL B.V., EINDHOVEN (NL)

(21) Appl. No.: 18/743,418

(22) Filed: Jun. 14, 2024

(51) Int. Cl. B60L 53/36; B60L 53/51; B60L 53/62; B60L 53/66; B60W 30/06; B60W 60/00

(52) U.S. Cl. CPC B60L 53/36; B60L 53/51; B60L 53/62; B60L 53/66; B60W 30/06; B60W 60/0023; B60W 2555/20

(57) ABSTRACT

Systems and methods for electric vehicle organization are provided. For example, a method for electric vehicle organization includes receiving charging capability information of one or more vehicles. The method also includes receiving information corresponding to charging profiles of the one or more vehicles. The method also includes determining charge point data in a given area associated with the one or more vehicles. The method also includes determining map object data and point of interest data in the given area. The method also includes generating a recommendation for an optimal charge position within the given area for a vehicle of the one or more vehicles based on a charging capability information of the vehicle, a charge profile of the vehicle, the determined charge point data in the given area, and the determined map object data and the point of interest data.

### TECHNICAL FIELD

The present disclosure relates generally to charging electric vehicles, and more specifically to systems and methods for maximizing charging efficiency of electric vehicles at electrical vehicle charge points.

### BACKGROUND

An electric vehicle is a vehicle that includes an electric propulsion system. The electric propulsion system may include an electric motor and a battery. Hybrid vehicles may also include a combustion engine as well as a regenerative power system that transfers excess power from the combustion engine to the electric propulsion system. Electric vehicles may be charged by an electric vehicle charge point. The electric vehicle charge points may be placed in parking garages, parking lots, or consumer homes. The electric vehicle may be electrically coupled to the charging station using a cord. Depending on the electrical input to the electric vehicle charge point, which may vary in amplitude and in number of phases, and the charging capabilities of various electric vehicles, the locations of different electric vehicle charge points may be capable of charging the electric vehicle in different amounts of time. However, there is no optimal way of organizing vehicles at electric vehicle charging points.

### BRIEF SUMMARY

The present disclosure overcomes the shortcomings of prior technologies. In particular, a novel approach for electric vehicle organization is provided, as detailed below.

In accordance with an aspect of the disclosure, a method for electric vehicle organization is provided. The method includes receiving charging capability information of one or more vehicles. The charging capability information includes at least electric vehicle charge point requirements of the one or more vehicles and solar panel information of the one or more vehicles. The method also includes receiving information corresponding to charging profiles of the one or more vehicles. The method also includes determining charge point data in a given area associated with the one or more vehicles. The method also includes determining map object data and point of interest data in the given area. The method also includes generating a recommendation for an optimal charge position within the given area for a vehicle of the one or more vehicles based on a charging capability information of the vehicle, a charge profile of the vehicle, the determined charge point data in the given area, and the determined map object data and the point of interest data.

In accordance with another aspect of the present disclosure, a non-transitory computer-readable storage medium is provided. The non-transitory computer-readable storage medium includes one or more sequences of one or more instructions for execution by one or more processors of an apparatus. The one or more instructions which, when executed by the one or more processors, cause the apparatus to perform the step of receiving information corresponding to hardware charging capabilities of a vehicle. The one or more instructions further cause the apparatus to perform the step of receiving information corresponding to a vehicle charging profile of the vehicle. The one or more instructions further cause the apparatus to perform the step of analyzing electric vehicle charge point data in a given area associated with the vehicle. The one or more instructions further cause the apparatus to perform the step of determining one or more electric vehicle charging spaces associated with a minimum level of direct exposure to the Sun based on an analysis of at least one of map object data and point of interest data in the given area. The one or more instructions further cause the apparatus to perform the step of generating a recommendation for an optimal electric vehicle charging space of the one or more electric vehicle charging spaces based on an analysis of at least one or more of the hardware charging capabilities of the vehicle, the charge profile of the vehicle, the electric vehicle charge point data, and the determined one or more electric vehicle charging spaces associated with a minimum level of direct exposure to the Sun. The one or more instructions further cause the apparatus to perform the step of providing one or more instructions for the vehicle to park at the optimal electric vehicle charging space.

In accordance with another aspect of the disclosure, a method for electric vehicle organization is provided. The method includes receiving parking data corresponding to one or more areas for parking vehicles. The method also includes analyzing one or more parking spaces of the one or more areas. The method also includes determining a charging score corresponding to each of the one or more parking spaces based on an analysis of the parking data. The method also includes based on the determined charging score corresponding to each of the one or more parking spaces, generating an output signal for moving a vehicle from a first parking space of the one or more parking spaces to a second parking space of the one or more parking spaces.

In addition, for various example embodiments, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment.

For various example embodiments, the following is also applicable: a method comprising facilitating access to at least one interface configured to allow access to at least one service, the at least one service configured to perform any one or any combination of network or service provider methods (or processes) disclosed in this application.

For various example embodiments, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment, and/or at least one signal resulting from one or any combination of methods (or processes) disclosed in this application as relevant to any embodiment.

For various example embodiments, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment, and/or at least one signal resulting from one or any combination of methods (or processes) disclosed in this application as relevant to any embodiment.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of the claims.

Still other aspects, features, and advantages are readily apparent from the following detailed description, simply by illustrating a number of particular embodiments and implementations. The drawings and description are to be regarded as illustrative in nature, and not as restrictive.

### BRIEF DESCRIPTION OF THE DRAWINGS

The embodiments are illustrated by way of example, and not by way of limitation, in the figures of the accompanying drawings:

FIG. 1 is a diagram of a system capable of electric vehicle organization, in accordance with aspects of the present disclosure;

FIG. 2 is a diagram of the components of a data analysis system, in accordance with aspects of the present disclosure;

FIG. 3 is a flowchart setting forth steps of an example process, in accordance with aspects of the present disclosure;

FIG. 4 is a flowchart setting forth steps of another example process, in accordance with aspects of the present disclosure;

FIG. 5 is a flowchart setting forth steps of another example process, in accordance with aspects of the present disclosure;

FIGS. 6A-6D are diagrams illustrating example scenarios for electric vehicle organization, in accordance with aspects of the present disclosure;

FIG. 7 is a diagram of a geographic database, in accordance with aspects of the present disclosure;

FIG. 8 is a diagram of an example computer system, in accordance with aspects of the present disclosure;

FIG. 9 is a diagram of an example chip set, in accordance with aspects of the present disclosure; and

FIG. 10 is a diagram of an example mobile device, in accordance with aspects of the present disclosure.

### DESCRIPTION OF SOME EMBODIMENTS

Examples of methods and a non-transitory computer-readable storage medium for electric vehicle organization are disclosed. In the following description, for the purposes of explanation, numerous specific details are set forth in order to provide a thorough understanding of the embodiments. It is apparent, however, to one skilled in the art that the embodiments may be practiced without these specific details or with an equivalent arrangement. In other instances, well-known structures and devices are shown in block diagram form in order to avoid unnecessarily obscuring the embodiments.

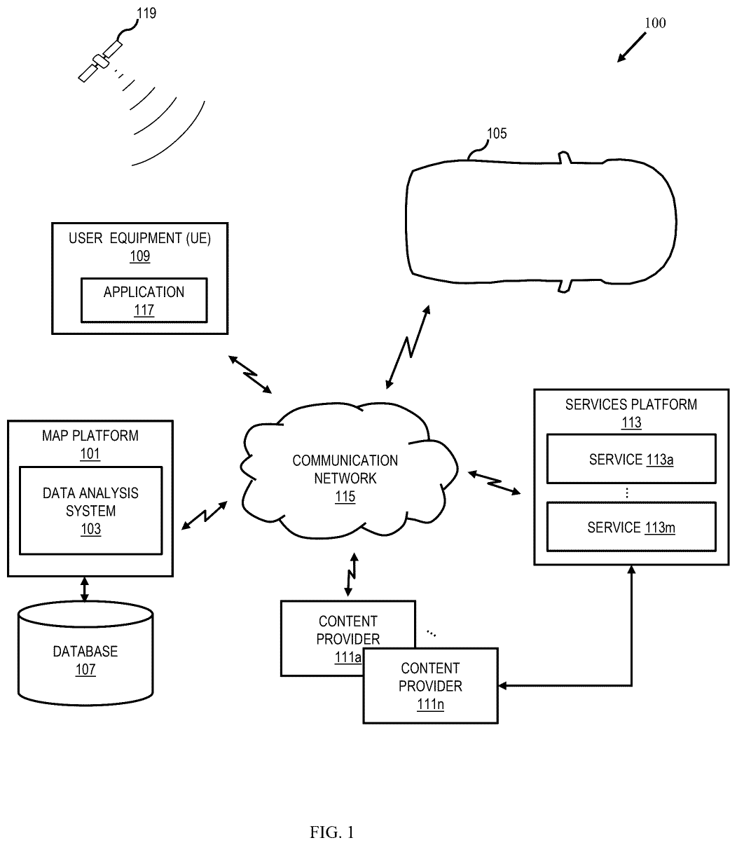

Referring to FIG. 1, the map platform 101 of the system 100 can be a standalone server or a component of another device with connectivity to the communication network 115. For example, the component can be part of an edge computing network where remote computing devices (not shown) are installed along or within proximity of a given geographical area.

The communication network 115 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, fifth generation mobile (5G) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the map platform 101 may be a platform with multiple interconnected components. The map platform 101 may include multiple servers, intelligent networking devices, computing devices, components and corresponding software for generating information for electric vehicle organization or other map functions. In addition, it is noted that the map platform 101 may be a separate entity of the system 100, a part of one or more services 113a-113m of a services platform 113.

The services platform 113 may include any type of one or more services 113a-113m. By way of example, the one or more services 113a-113m may include weather services, mapping services, navigation services, travel planning services, notification services, social networking services, content (e.g., audio, video, images, etc.) provisioning services, application services, storage services, information for electric vehicle organization, location-based services, news services, etc. In one embodiment, the services platform 113 may interact with the map platform 101, and/or one or more content providers 111a-111n to provide the one or more services 113a-113m.

In one embodiment, the one or more content providers 111a-111n may provide content or data to the map platform 101, and/or the one or more services 113a-113m. The content provided may be any type of content, mapping content, textual content, audio content, video content, image content, etc. In one embodiment, the one or more content providers 111a-111n may provide content that may aid in electric vehicle organization according to the various embodiments described herein. In one embodiment, the one or more content providers 111a-111n may also store content associated with the map platform 101, and/or the one or more services 113a-113m. In another embodiment, the one or more content providers 111a-111n may manage access to a central repository of data, and offer a consistent, standard interface to data.

In one embodiment, the vehicle 105 may be a hybrid vehicle, an electric vehicle, and/or any other mobility implement type of vehicle. The vehicle 105 includes parts related to mobility, such as a powertrain with an engine, a transmission, a suspension, a driveshaft, and/or wheels, etc. In another example, the vehicle 105 may be an autonomous vehicle. The autonomous vehicle may be a manually controlled vehicle, semi-autonomous vehicle (e.g., some routine motive functions, such as parking, are controlled by the vehicle), or an autonomous vehicle (e.g., motive functions are controlled by the vehicle without direct driver input).

The autonomous level of a vehicle can be a Level 0 autonomous level that corresponds to no automation for the vehicle, a Level 1 autonomous level that corresponds to a certain degree of driver assistance for the vehicle, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle. In one embodiment, user equipment (e.g., a mobile phone, a portable electronic device, etc.) may be integrated in the vehicle, which may include assisted driving vehicles such as autonomous vehicles, highly assisted driving (HAD), and advanced driving assistance systems (ADAS). Any of these assisted driving systems may be incorporated into the user equipment. Alternatively, an assisted driving device may be included in the vehicle.

The term autonomous vehicle may refer to a self-driving or driverless mode in which no passengers are required to be on board to operate the vehicle. An autonomous vehicle may be referred as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate and respond to lane marking indicators (lane marking type, lane marking intensity, lane marking color, lane marking offset, lane marking width, or other characteristics) and driving commands or navigation commands.

In one embodiment, the vehicle 105 may be an HAD vehicle or an ADAS vehicle. An HAD vehicle may refer to a vehicle that does not completely replace the human operator. Instead, in a highly assisted driving mode, the vehicle may perform some driving functions and the human operator may perform some driving functions. Vehicles may also be driven in a manual mode in which the human operator exercises a degree of control over the movement of the vehicle. The vehicles may also include a completely driverless mode. Other levels of automation are possible. The HAD vehicle may control the vehicle through steering or braking in response to the position of the vehicle and may respond to lane marking indicators (lane marking type, lane marking intensity, lane marking color, lane marking offset, lane marking width, or other characteristics) and driving commands or navigation commands. Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) and driving commands or navigation commands.

In one embodiment, the user equipment (UE) 109 may be, or include, an embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 109 may support any type of interface with a user (e.g., by way of various buttons, touch screens, consoles, displays, speakers, “wearable” circuitry, and other I/O elements or devices). Although shown in FIG. 1 as being separate from the vehicle 105, in some embodiments, the UE 109 may be integrated into, or part of, the vehicle 105.

In one embodiment, the UE 109, may execute one or more applications 117 (e.g., software applications) configured to carry out steps in accordance with methods described here. For instance, in one non-limiting example, the application 117 may carry out steps for electric vehicle organization. In another non-limiting example, application 117 may also be any type of application that is executable on the UE 109 and/or vehicle 105, such as autonomous driving applications, mapping applications, location-based service applications, navigation applications, content provisioning services, camera/imaging application, media player applications, social networking applications, calendar applications, and the like. In yet another non-limiting example, the application 117 may act as a client for the data analysis system 103 and perform one or more functions associated with electric vehicle organization, either alone or in combination with the data analysis system 103.

In some embodiments, the UE 109, and/or the vehicle 105 may include various sensors for acquiring a variety of different data or information. For instance, the UE 109, and/or the vehicle 105 may include one or more camera/imaging devices for capturing imagery (e.g., terrestrial images), global positioning system (GPS) sensors or Global Navigation Satellite System (GNSS) sensors for gathering location or coordinates data, network detection sensors for detecting wireless signals, receivers for carrying out different short-range communications (e.g., Bluetooth, Wi-Fi, Li-Fi, near field communication (NFC) etc.), temporal information sensors, Light Detection and Ranging (LIDAR) sensors, Radio Detection and Ranging (RADAR) sensors, audio recorders for gathering audio data, velocity sensors, switch sensors for determining whether one or more vehicle switches are engaged, and others.

The UE 109, and/or the vehicle 105 may also include one or more light sensors, height sensors, accelerometers (e.g., for determining acceleration and vehicle orientation), magnetometers, gyroscopes, inertial measurement units (IMUs), tilt sensors (e.g., for detecting the degree of incline or decline), moisture sensors, pressure sensors, and so forth. Further, the UE 109, and/or the vehicle 105 may also include sensors for detecting the relative distance of the vehicle 105 from a lane or roadway, the presence of other vehicles, pedestrians, traffic lights, lane markings, speed limits, road dividers, potholes, and any other objects, or a combination thereof. Other sensors may also be configured to detect weather data, traffic information, or a combination thereof. Yet other sensors may also be configured to determine the status of various control elements of the car, such as activation of wipers, use of a brake pedal, use of an acceleration pedal, angle of the steering wheel, activation of hazard lights, activation of head lights, and so forth.

In some embodiments, the UE 109, and/or the vehicle 105 may include GPS, GNSS or other satellite-based receivers configured to obtain geographic coordinates from a satellite 119 for determining current location and time. Further, the location can be determined by visual odometry, triangulation systems such as A-GPS, Cell of Origin, or other location extrapolation technologies, and so forth. In some embodiments, two or more sensors or receivers may be co-located with other sensors on the UE 109, and/or the vehicle 105.

By way of example, the map platform 101, the services platform 113, and/or the one or more content providers 111a-111n communicate with each other and other components of the system 100 using well known, new or still developing protocols. In this context, a protocol includes a set of rules defining how the network nodes within the communication network 115 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6, and layer 7) headers as defined by the OSI Reference Model.

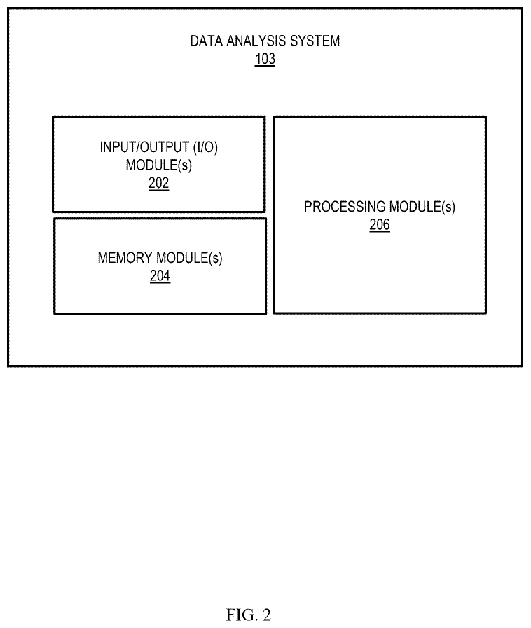

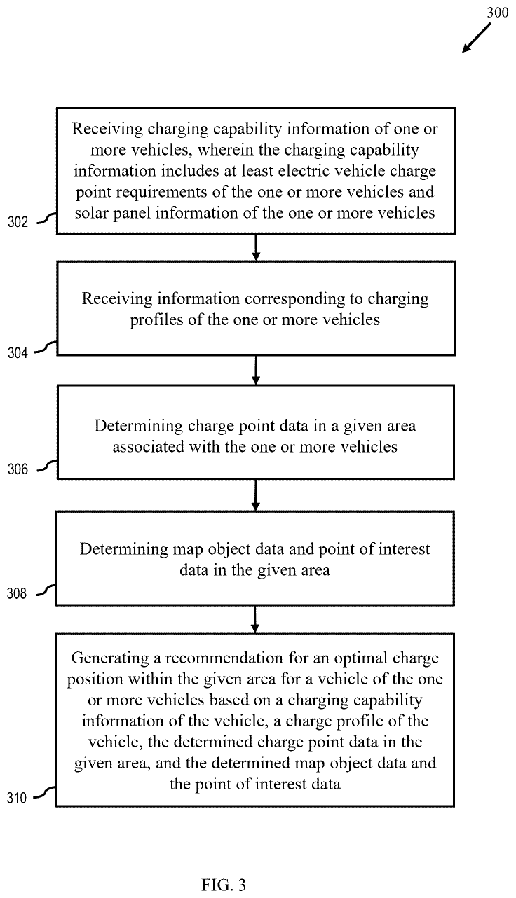

FIG. 2 is a diagram of the components of the data analysis system 103 of FIG. 1, according to one embodiment. By way of example, the data analysis system 103 includes one or more components for electric vehicle organization according to the various embodiments described herein. It is contemplated that the functions of these components may be combined or performed by other components of equivalent functionality. In this embodiment, data analysis system 103 includes in input/output module 202, a memory module 204, and a processing module 206. The above presented modules and components of the data analysis system 103 can be implemented in hardware, firmware, software, or a combination thereof. Though depicted as a separate entity in FIG. 1, it is contemplated that the data analysis system 103 may be implemented as a module of any of the components of the system 100 (e.g., a component of the services platform 113, etc.). In another embodiment, one or more of the modules 202-206 may be implemented as a cloud-based service, local service, native application, or combination thereof. The functions of these modules are discussed with respect to FIGS. 3-5 below.

FIG. 3 is a flowchart of an example method, in accordance with at least some of the embodiments described herein. Although the blocks in each figure are illustrated in a sequential order, the blocks may in some instances be performed in parallel, and/or in a different order than those described therein. Also, the various blocks may be combined into fewer blocks, divided into additional blocks, and/or removed based upon the desired implementation.

In addition, the flowchart of FIG. 3 shows the functionality and operation of one possible implementation of the present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include non-transitory computer-readable media that stores data for short periods of time, such as register memory, processor cache, or Random Access Memory (RAM), and/or persistent long term storage, such as read only memory (ROM), optical or magnetic disks, or compact-disc read only memory (CD-ROM), for example. The computer readable media may also be, or include, any other volatile or non-volatile storage systems. The computer readable medium may be considered a computer readable storage medium, a tangible storage device, or other article of manufacture, for example.

Alternatively, each block in FIG. 3 may represent circuitry that is wired to perform the specific logical functions in the process. An illustrative method, such as that shown in FIG. 3, may be carried out in whole or in part by a component or components in the cloud and/or system. However, it should be understood that the example methods may instead be carried out by other entities or combinations of entities (i.e., by other computing devices and/or combinations of computing devices), without departing from the scope of the invention. For example, functions of the method of FIG. 3 may be fully performed by a computing device (or components of a computing device such as one or more processors) or may be distributed across multiple components of the computing device, across multiple computing devices, and/or across a server.

Referring to FIG. 3, an example method 300 may include one or more operations, functions, or actions as illustrated by blocks 302-310. The blocks 302-310 may be repeated periodically or performed intermittently, or as prompted by a user, device, or system. In one embodiment, the method 300 is implemented in whole or in part by the data analysis system 103 of FIG. 1.

As shown by block 302, the method 300 includes, receiving charging capability information of one or more vehicles, wherein the charging capability information includes at least electric vehicle charge point requirements of the one or more vehicles and solar panel information of the one or more vehicles. In one example, the input/output module 202 of FIG. 2 is configured to receive the charging capability of the one or more vehicles. In one example, the charging capability information includes the type of electric vehicle charging connectors compatible with the vehicle, the number of solar cells coupled to the vehicle, and the orientation of the solar cells relative to the vehicle.

As shown by block 304, the method 300 also includes, receiving information corresponding to charging profiles of the one or more vehicles. In one example, the input/output module 202 of FIG. 2 is configured to receive the information corresponding to charging profiles of the one or more vehicles. In one example, the charging profiles of the one or more vehicles include a set of instructions that an electric vehicle charger follows for optimal charging of the one or more batteries of a vehicle. In another example, the charging profiles may also include an electric vehicle charge start time, an initial battery state-of-charge (SOC), and a total charging time.

As shown by block 306, the method 300 also includes, determining charge point data in a given area associated with the one or more vehicles. In one example, the processing module 206 of FIG. 2 is configured to determine charge point data in a given area associated with the one or more vehicles. In one example, the processing module 206 is configured to communicate with one or more components of the system 100 of FIG. 1. For example, the processing module 206 may be configured to communicate via the input/output module 202 with the database 107, one or more of the content provider 111a-111n, and the services platform 113 in order to obtain charge point data in the given area associated with the one or more vehicles. Continuing with this example, the processing module 206 may receive information of nearby electric vehicle charge points such as the location of each electric vehicle charge point, the status associated with each electric vehicle charge point, and the type of chargers (alternating current chargers, direct current fast chargers, etc.) at each electric vehicle charge point.

As shown by block 308, the method 300 also includes, determining map object data and point of interest data in the given area. In one example, the processing module 206 of FIG. 2 is configured to determine map object data and point of interest data in the given area. In one embodiment, the processing module 206 is configured to determine the map object data and point of interest data in the given area. In one embodiment, the processing module 206 is also configured to determine one or more expected shadows in one or more charge positions based on the map object data the point of interest data. In this embodiment, the processing module 206 is also configured to determine an expected amount of charge available to the vehicle via the at least one solar panel based on an analysis of the determined one or more expected shadows in one or more charge positions. In one scenario, the processing module 206 may receive, via the input/output module 202, image data that includes shadows corresponding to the one or more charge positions from one or more of the content provider 111a-111n of FIG. 1 and the services platform 113 of FIG. 1. In this scenario, the image data may span different periods of time throughout the day in addition to various days of the year to account for the differences of orbital position of the Earth relative to the Sun.

In one example, the map object data includes information about objects in the given area that could cast a shadow over one or more parking spaces. In one scenario, the map object data may include one or more trees that are adjacent to the one or more parking spaces. In another scenario, the map object data may include a billboard sign that is nearby the one or more parking spaces. In another example, the point of interest data may include information about various building structures that are next to one or more parking spaces. By way of example, the building structures may be commercial buildings, residential buildings, parking structures, etc. In one example, the processing module 206 may be configured to analyze a given area and determine which elements in the given area, based on the map object data and the point of interest data, are capable of casting a shadow over one or more parking spaces. In this example, the determined one or more elements may be determined according to an analysis of map attributes associated with the given area.

As shown by block 310, the method 300 also includes generating a recommendation for an optimal charge position within the given area for a vehicle of the one or more vehicles based on a charging capability information of the vehicle, a charge profile of the vehicle, the determined charge point data in the given area, and the determined map object data and the point of interest data. In one example, the processing module 206 of FIG. 2 is configured to generate a recommendation for an optimal charge position within the given area for a vehicle of the one or more vehicles based on a charging capability information of the vehicle, a charge profile of the vehicle, the determined charge point data in the given area, and the determined map object data and the point of interest data. In one embodiment, generating the recommendation for the optimal charge position within the given area further includes a recommended interval of time for charging a vehicle of the one or more vehicles via a solar panel of the vehicle.

In one scenario, the processing module 206 may be configured to generate the recommendation for an electric vehicle that is equipped with a solar panel and requires access to an alternating current charger. In this scenario, the processing module 206 may be configured to determine one or more parking spaces that have an unobstructed area for parking the electric vehicle based on the map object data and the point of interest data. Continuing with this scenario, the processing module 206 may retrieve image data from one or more components of system 100 of FIG. 1 and analyze the image data to determine which of the one or more parking spaces are covered under the shade of various objects or structures in the area. The processing module 206 may be configured to select an optimal parking space based on the analysis of the image data and generate the recommendation for the electric vehicle.

In another embodiment, the method 300 may further include, analyzing weather data corresponding to the given area associated with the one or more vehicles. In this embodiment, the method 300 may further include, generating the recommendation for the optimal charge position within the given area for the vehicle of the one or more vehicles based on the charging capability information of the vehicle, the charge profile of the vehicle, the determined charge point data in the give area, the determined map object data and the point of interest data, and the weather data corresponding to the given area. In one scenario, the vehicle is an autonomous vehicle and generating a recommendation for the optimal charge position includes providing an autonomous vehicle control signal to the vehicle that enables the vehicle to move from a first position to the optimal charge position based on analysis of the weather data.

In another embodiment, the method 300 may further include, receiving a request to charge a battery of a parked vehicle of the one or more vehicles. In this embodiment, the method 300 may further include, determining a preferred charge level associated with the parked vehicle. Continuing with this embodiment, the method 300 may further include, based on the preferred charge level, generating a recommendation for moving the parked vehicle to a charge position for charging the parked vehicle via a solar panel of the parked vehicle. For example, if an individual has left the vehicle at a parking structure nearby an airport while the individual is on a trip, then the individual would not be expected to utilize the vehicle until the individual returns from the trip. While the vehicle is in one of the lower levels of the parking structure, the vehicle will not be able to charge the battery via a solar panel of the vehicle. This may be acceptable or preferred during the first part of the individual's trip. However, to obtain a certain level of charge via the solar panel, the vehicle would need to be moved to the upper level of the parking structure at some point prior to the end of the individual's trip. In this example, a system (e.g., data analysis system 103 of FIG. 1, system 100 of FIG. 1) could be configured to determine the number of days that the vehicle should be moved from a lower level of the parking structure to the upper level of the parking structure that exposes the vehicle to direct sunlight for charging the battery of the vehicle via the solar panel to a certain level of charge. This could enable the system to manage one or more vehicles that are capable of charging batteries via solar panels in view of the limited parking spaces on the upper level of a parking structure.

In another embodiment, the method 300 may further include, analyzing expected usage data corresponding to a parked vehicle of the one or more vehicles. In this embodiment, the method 300 may further include, generating the recommendation for the optimal charge position within the given area for the vehicle of the one or more vehicles based on the charging capability of the vehicle, the charge profile of the vehicle, the determined charge point data in the give area, the determined map object data and the point of interest data, and the usage data corresponding to the parked vehicle. For example, if the individual has parked the vehicle at a parking lot designated for commuters to board a train into a metropolitan area, then the expected usage may be based on when an individual is expected to return via one or more train schedules. In this example, the system may analyze image data of the parking lot to determine the optimal charge position so that the vehicle is an optimal space for charging the battery via a solar panel.

In another embodiment, the method 300 may further include, providing a signal to a mobile apparatus that is configured to move the vehicle from a first position to the optimal charge position. In one example, the mobile apparatus may be an autonomous parking robot that is configured to move a parked vehicle from a first location to a second location. The autonomous parking robot may be configured to slide underneath the vehicle and lift the vehicle by the tires for repositioning the vehicle to another location without the need of a driver in the vehicle. In one example, a system (e.g., data analysis system 103 of FIG. 1, system 100 of FIG. 1), may be configured to provide one or more signals to the autonomous parking robot that include the location of the parked vehicle and the location of the optimal charge position.

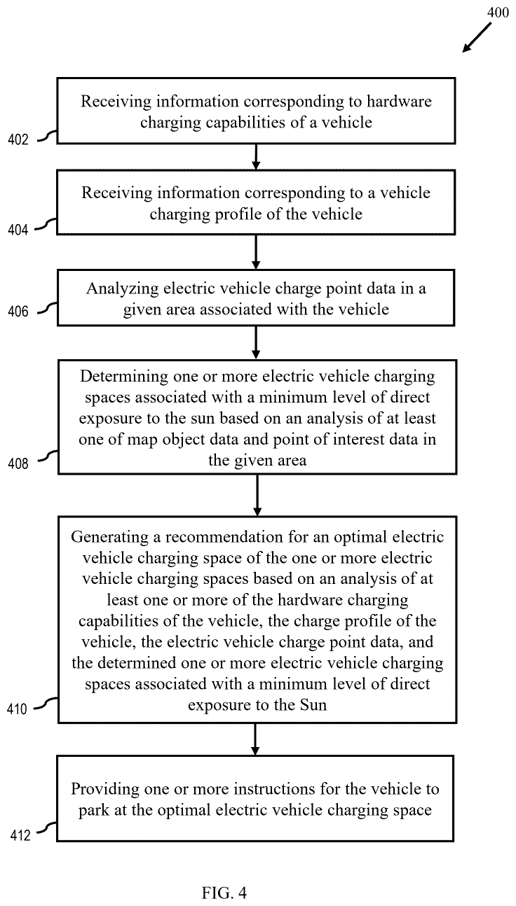

FIG. 4 is a flowchart of another example method, in accordance with at least some of the embodiments described herein. Although the blocks in each figure are illustrated in a sequential order, the blocks may in some instances be performed in parallel, and/or in a different order than those described therein. Also, the various blocks may be combined into fewer blocks, divided into additional blocks, and/or removed based upon the desired implementation.

In addition, the flowchart of FIG. 4 shows the functionality and operation of one possible implementation of the present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include non-transitory computer-readable media that stores data for short periods of time, such as register memory, processor cache, or Random Access Memory (RAM), and/or persistent long term storage, such as read only memory (ROM), optical or magnetic disks, or compact-disc read only memory (CD-ROM), for example. The computer readable media may also be, or include, any other volatile or non-volatile storage systems. The computer readable medium may be considered a computer readable storage medium, a tangible storage device, or other article of manufacture, for example.

Alternatively, each block in FIG. 4 may represent circuitry that is wired to perform the specific logical functions in the process. An illustrative method, such as that shown in FIG. 4, may be carried out in whole or in part by a component or components in the cloud and/or system. However, it should be understood that the example methods may instead be carried out by other entities or combinations of entities (i.e., by other computing devices and/or combinations of computing devices), without departing from the scope of the invention. For example, functions of the method of FIG. 4 may be fully performed by a computing device (or components of a computing device such as one or more processors) or may be distributed across multiple components of the computing device, across multiple computing devices, and/or across a server.

As shown by block 402, the method 400 includes, receiving information corresponding to hardware charging capabilities of a vehicle. In one example, the input/output module 202 of FIG. 2 is configured to receive information corresponding to hardware charging capabilities of a vehicle. In one example, the hardware charging capabilities includes information corresponding to the electric vehicle charge point requirements of the vehicle and information corresponding to at least one solar panel coupled to the vehicle. In one scenario, the vehicle is a plug-in hybrid electric vehicle that is equipped with a solar panel for charging the battery of the vehicle. In this scenario, the input/output module 202 would receive the type of chargers that the plug-in hybrid electric vehicle is capable of utilizing in addition to information pertaining to a solar panel that is equipped to the vehicle. In one example, the input/output module 202 is configured to communicate with a mobile device (e.g., UE 109 of FIG. 1) of the driver of the electric vehicle for receiving the hardware charging capabilities of the vehicle.

As shown by block 404, the method 400 also includes, receiving information corresponding to a vehicle charging profile of the vehicle. In one example, the input/output module 202 of FIG. 2 is configured to receive information corresponding to a vehicle charging profile of the vehicle. In one scenario, the charging profile of a plug-in hybrid electric vehicle may indicate the differences in required charging time based on the level charger (e.g., Level 1 EV charger, Level 2 EV charger, etc.) utilized and the charging time based on the use of a solar panel coupled to the vehicle.

As shown by block 406, the method 400 also includes, analyzing electric vehicle charge point data in a given area associated with the vehicle. In one example, the processing module 206 of FIG. 2 is configured to analyze electric vehicle charge point data in a given area associated with the vehicle. In one example, the processing module 206 is configured to communicate with one or more databases that includes all the electrical vehicle chargers that are registered with the system 100 of FIG. 1 for providing charging locations for electric vehicles in the given area. By way of example, the database may include information such as the number of charging ports and the types of electric vehicles for which the electrical vehicle chargers may be used. In one example, the processing module 206 may be configured to determine which electric vehicle chargers may be utilized for charging the electrical vehicle based upon information stored within the one or more databases.

As shown by block 408, the method 400 also includes, determining one or more electric vehicle charging spaces associated with a minimum level of direct exposure to the Sun based on an analysis of at least one of map object data and point of interest data in the given area. In one example, the processing module 206 of FIG. 2 is configured to determine one or more electric vehicle charging spaces associated with a minimum level of direct exposure to the sun based on an analysis of at least one of map object data and point of interest data in the given area. For example, the processing module 206 may be configured to receive image data corresponding to the map object data and point of interest data. By way of example, the image data may be used to determine how the sunlight changes at one or more electric vehicle charging spaces over time. In one example, the processing module 206 may be configured to determine at what time of day sunlight covers the one or more vehicle charging spaces, at what time of day the one or more vehicle charging spaces are covered by shadows, the direction that the sunlight approaches, as well as what time the Sun sets/rises throughout the year.

As shown by block 410, the method 400 also includes, generating a recommendation for an optimal electric vehicle charging space of the one or more electric vehicle charging spaces based on an analysis of at least one or more of the hardware charging capabilities of the vehicle, the charge profile of the vehicle, the electric vehicle charge point data, and the determined one or more electric vehicle charging spaces associated with a minimum level of direct exposure to the Sun. In one example, the processing module 206 of FIG. 2 is configured to generate a recommendation for an optimal electric vehicle charging space of the one or more electric vehicle charging spaces based on an analysis of at least one or more of the hardware charging capabilities of the vehicle, the charge profile of the vehicle, the electric vehicle charge point data, and the determined one or more electric vehicle charging spaces associated with a minimum level of direct exposure to the Sun. In one example, generating the recommendation for the optimal electrical vehicle charging space may also be based on one or more scores corresponding to the electric vehicle charging spaces. For example, the processing module 206 may be configured to assign scores to each of the electrical vehicle charging spaces based on the analysis of at least one or more of the hardware charging capabilities of the vehicle, the charge profile of the vehicle, the electric vehicle charge point data, and the determined minimum level of direct exposure to the Sun at the one or more electric vehicle charging spaces.

In one example, generating the recommendation for an optimal electric vehicle charging space of the one or more electric vehicle charging spaces further includes determining an expected usage of the vehicle. In this example, generating the recommendation for the optimal electric vehicle charging space of the one or more electric vehicle charging spaces is based on an analysis of at least one or more of the hardware charging capabilities of the vehicle, the charge profile of the vehicle, the electric vehicle charge point data, the determined one or more electric vehicle charging spaces associated with a minimum level of direct exposure to the Sun, and the expected usage of the vehicle.

In another example, generating the recommendation for an optimal electric vehicle charging space of the one or more electric vehicle charging spaces further includes determining one or more charging spaces of the one or more electric vehicle charging spaces that satisfy an expected charge based on analysis of indirect sunlight corresponding to the charging space. In this example, generating the recommendation for the optimal electric vehicle charging space of the one or more electric vehicle charging spaces is based on an analysis of at least one or more of the hardware charging capabilities of the vehicle, the charge profile of the vehicle, the electric vehicle charge point data, the determined one or more electric vehicle charging spaces associated with a minimum level of direct exposure to the Sun, and the determined one or more charging spaces.

In another example generating the recommendation for an optimal electric vehicle charging space of the one or more electric vehicle charging spaces further includes analyzing one or more images that include an aerial view of the one more electric vehicle charging spaces. Based on the analysis, the method includes determining a score associated with each of the one or more electric vehicle charging spaces. Continuing with this example, generating the recommendation for the optimal electric vehicle charging space of the one or more electric vehicle charging spaces based on an analysis of at least one or more of the hardware charging capabilities of the vehicle, the charge profile of the vehicle, the electric vehicle charge point data, the determined one or more electric vehicle charging spaces associated with a minimum level of direct exposure to the Sun, and the determined score associated with each of the one or more electric vehicle charging spaces.

In another example, generating the recommendation for an optimal electric vehicle charging space of the one or more electric vehicle charging spaces further includes analyzing weather data corresponding to the given area associated with the one or more vehicles. In this example, generating the recommendation for the optimal electric vehicle charging space of the one or more electric vehicle charging spaces based on an analysis of at least one or more of the hardware charging capabilities of the vehicle, the charge profile of the vehicle, the electric vehicle charge point data, the determined one or more electric vehicle charging spaces associated with a minimum level of direct exposure to the Sun, and the weather data corresponding to the given area.

As shown by block 412, the method 400 also includes, providing one or more instructions for the vehicle to park at the optimal electric vehicle charging space. In one example, the processing module 206 of FIG. 2 is configured to provide one or more instructions for the vehicle to park at the optimal electric vehicle charging space. In one example, the instructions are provided as the vehicle approaches the area. In another example, the instructions are provided to the vehicle after the vehicle has parked. In this example, the vehicle may be equipped with autonomous features that enable the vehicle to move from one position to a second position. In another example, the instructions are provided to a mobile device (e.g., UE 109 of FIG. 1).

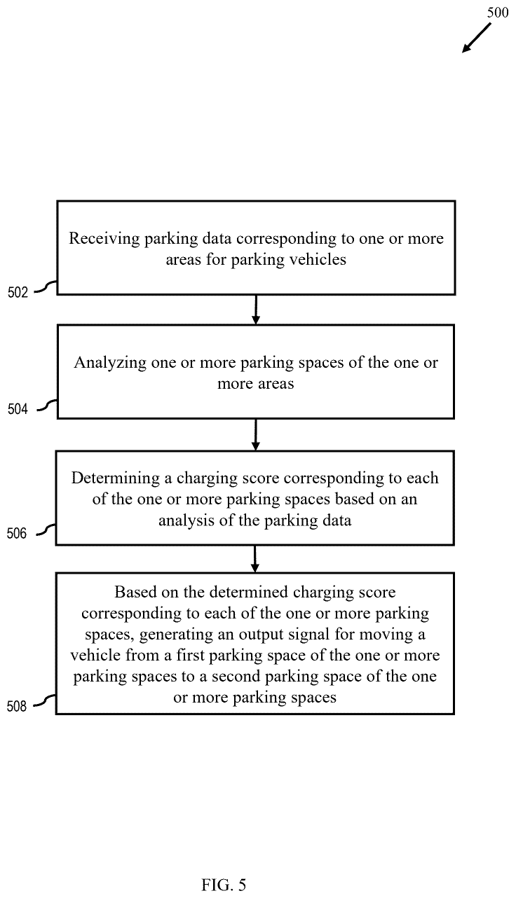

FIG. 5 is a flowchart of another example method, in accordance with at least some of the embodiments described herein. Although the blocks in each figure are illustrated in a sequential order, the blocks may in some instances be performed in parallel, and/or in a different order than those described therein. Also, the various blocks may be combined into fewer blocks, divided into additional blocks, and/or removed based upon the desired implementation.

In addition, the flowchart of FIG. 5 shows the functionality and operation of one possible implementation of the present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include non-transitory computer-readable media that stores data for short periods of time, such as register memory, processor cache, or Random Access Memory (RAM), and/or persistent long term storage, such as read only memory (ROM), optical or magnetic disks, or compact-disc read only memory (CD-ROM), for example. The computer readable media may also be, or include, any other volatile or non-volatile storage systems. The computer readable medium may be considered a computer readable storage medium, a tangible storage device, or other article of manufacture, for example.

Alternatively, each block in FIG. 5 may represent circuitry that is wired to perform the specific logical functions in the process. An illustrative method, such as that shown in FIG. 5, may be carried out in whole or in part by a component or components in the cloud and/or system. However, it should be understood that the example methods may instead be carried out by other entities or combinations of entities (i.e., by other computing devices and/or combinations of computing devices), without departing from the scope of the invention. For example, functions of the method of FIG. 5 may be fully performed by a computing device (or components of a computing device such as one or more processors) or may be distributed across multiple components of the computing device, across multiple computing devices, and/or across a server.

As shown by block 502, the method 500 includes, receiving parking data corresponding to one or more areas for parking vehicles. In one example, the input/output module 202 of FIG. 2 is configured to receive parking data corresponding to one or more areas for parking vehicles. In one example, the one or more areas for parking vehicles are part of a parking structure. In this example, the parking structure includes a plurality of levels of parking.

As shown by block 504, the method 500 also includes, analyzing one or more parking spaces of the one or more areas. In one example, the processing module 206 of FIG. 2 is configured to analyze one or more parking spaces of the one or more areas. In one example, analyzing the one or more parking spaces of the one or more areas includes an analysis of the amount of direct and indirect sunlight associated with the one or more parking spaces. In one scenario, the processing module 206 is configured to analyze the amount of direct and indirect sunlight based on the presence of one or more buildings adjacent to the one or more parking spaces. By way of example, a building that is covered with reflective glass may cause indirect sunlight to be directed towards the one or more parking spaces. In another example, little to no indirect sunlight could be directed to the one or more parking spaces based on a building that has no windows.

As shown by block 506, the method 500 also includes, determining a charging score corresponding to each of the one or more parking spaces based on an analysis of the parking data. In one example, the processing module 206 of FIG. 2 is configured to determine a charging score corresponding to each of the one or more parking spaces based on an analysis of the parking data. In one embodiment, the charging score may be based on the area that a parking space is covered by shadows during the day. For example, the processing module 206 may be configured to analyze map object data and point of interest data to determine shadows that are cast from various objects and buildings in a given area. By way of example, the processing module may be configured to determine the area of each parking space by determining the area between two markings that correspond to the left and right boundaries of the parking space. Continuing with this example, the processing module 206 may be configured to analyze an image and determine what percent of the area of each parking space is covered by a shadow. In one example, the processing module 206 may be configured to assign a numerical score. In one scenario, a parking space that is not covered by any shadows during the day may be assigned a score of 100. In this scenario, a parking space that is covered by shadows for half the day may be assigned a score of 50. Continuing with this scenario, a parking space that is covered by shadows the entire day may be assigned a score of 0. In one embodiment, the scores for each parking space may be updated throughout the day in order to account for the change in the position of the Earth relative to the Sun. In one example, the charging scores could be more relevant to vehicles that are equipped with solar panels than vehicles that do not have solar panels.

As shown by block 508, the method 500 also includes, based on the determined charging score corresponding to each of the one or more parking spaces, generating an output signal for moving a vehicle from a first parking space of the one or more parking spaces to a second parking space of the one or more parking spaces. In one example, the processing module 206 of FIG. 2 is configured to, based on the determined charging score corresponding to each of the one or more parking spaces, generate an output signal for moving a vehicle from a first parking space of the one or more parking spaces to a second parking space of the one or more parking spaces. In one example, generating the output signal for moving the vehicle from the first parking space of the one or more parking spaces to the second parking space of the one or more parking spaces causes a mobile apparatus to move the vehicle from the first parking space to the second parking space. In another example, the vehicle is an autonomous vehicle. In this example, generating the output signal for moving the autonomous vehicle from the first parking space of the one or more parking spaces to the second parking space of the one or more parking spaces causes the vehicle to operate autonomously and reposition the vehicle from the first parking space to the second parking space.

In one embodiment, the method 500 may further include, analyzing weather data corresponding to the parking structure. In this embodiment, the method 500 may further include, determining the charging score corresponding to each of the one or more parking spaces based on an analysis of the parking data and the weather data. In one example, the processing module 206 of FIG. 2 may be configured to analyze the weather data. In one scenario, the weather data may indicate that a winter storm is expected and will lead to cold temperatures and an accumulation of snow. In this scenario, the processing module 206 may lower a charging score associated with one or more parking spaces of the parking structure that are on the top level and increase the charging score associated with one or more parking spaces that are covered and therefore more likely to be protected from the winter storm. In this embodiment and others, ambient/exterior temperature data may also be used when calculating the charge score or otherwise determining optimal charge position of a vehicle with solar charging capabilities. For example, extreme cold or heat may negatively impact charging to the extent that charging in an open, uncovered parking lot is less efficient than charging in a partially covered parking spot where sunlight may still be absorbed. Battery age, etc. may also be factored into the charging optimization analysis as discussed throughout the disclosure.

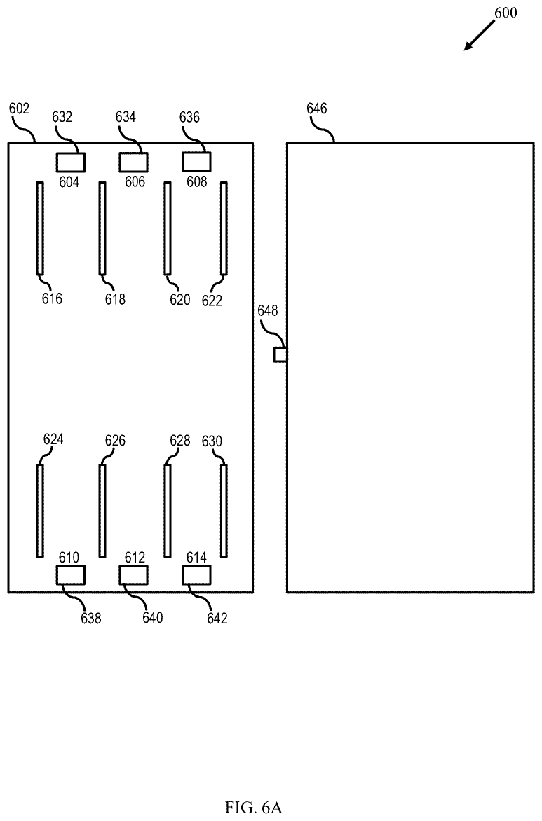

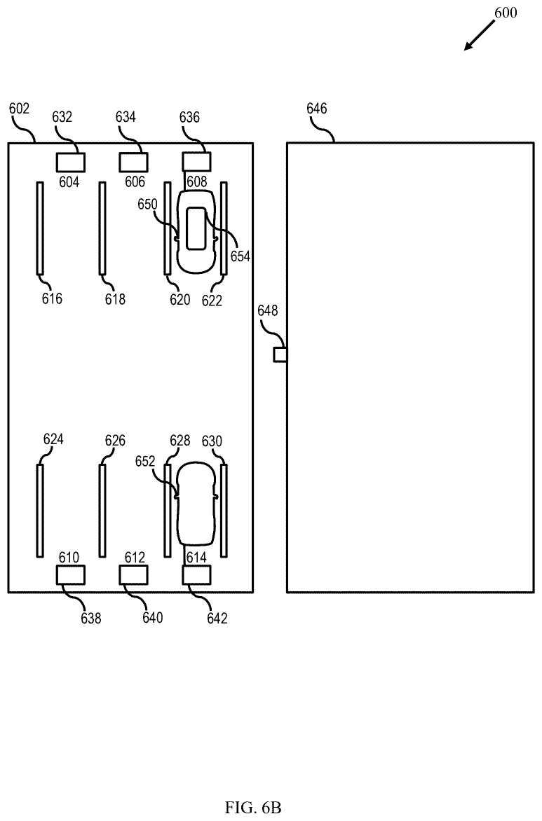

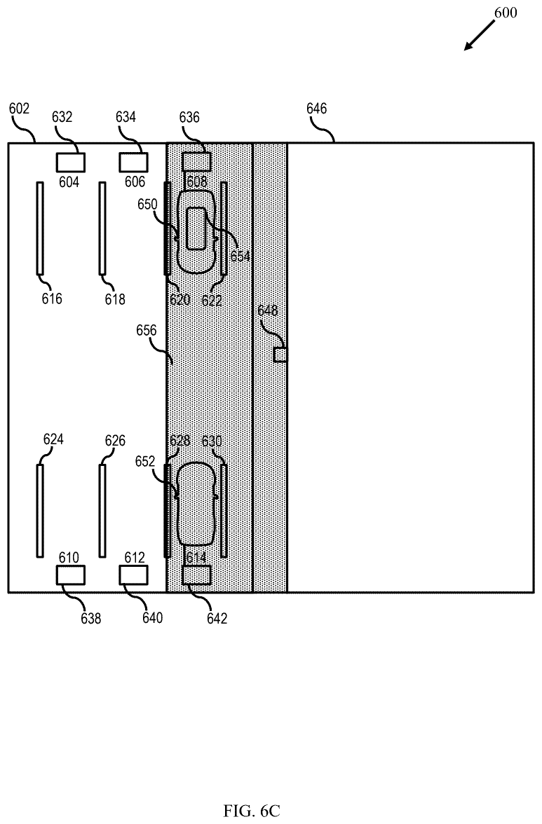

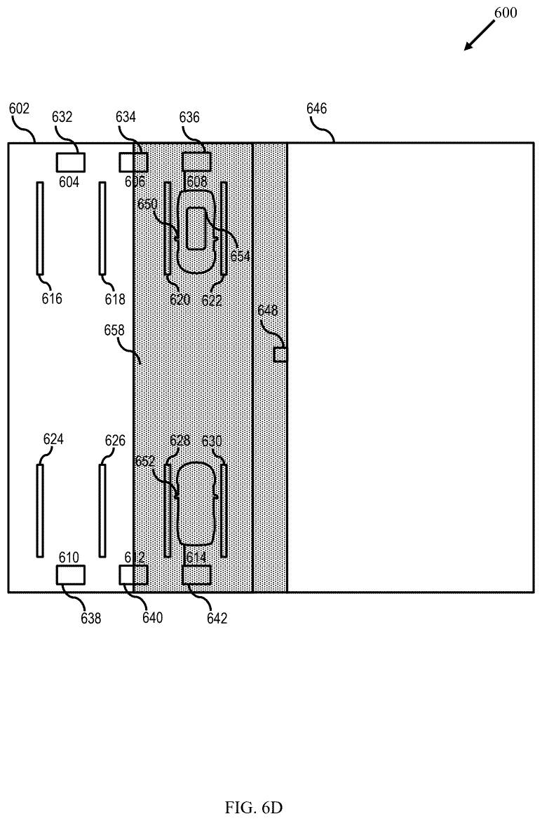

FIGS. 6A-6D are diagrams illustrating an example environment 600 for electric vehicle organization in various scenarios. As shown, FIG. 6A corresponds to a top-view of the example environment 600. It is noted that the relative dimensions in FIG. 6 are for exemplary purposes only. In other examples, the top-view may contain one or more additional objects or areas associated with the example outdoor space. Within the example environment 600, a parking lot 602 is shown adjacent to a building 646.

The parking lot 602 includes electric vehicle charge points 632, 634, 636, 638, 640, and 642. The parking lot 602 also includes parking spaces 604, 606, 608, 610, 612, and 614. The parking spaces 604-614 are defined according to the markings 616, 618, 620, 622, 624, 626, 628, 630. For example, the area corresponding to the parking space 604 is defined as the area between marking 616 and marking 618. Each of the electric vehicle charge points 632-636 is configured to be used with the corresponding parking spaces 604-614. For example, the electric vehicle charge point 632 is configured to be used with the parking space 604. In one example, a vehicle (e.g., vehicle 105 from FIG. 1) is capable of parking in any of the parking spaces 604-614 and utilizing a corresponding electric vehicle charge point to charge a vehicle battery associated with the vehicle. The building 646 includes a camera 648 that is coupled to the building 646. The camera 648 may be configured to capture images or video of the parking lot 602.

As shown, FIG. 6B corresponds to the top-view of the example environment 600 of FIG. 6A. In a first scenario, the example environment 600 in FIG. 6B includes a first vehicle 650 and a second vehicle 652. The first vehicle 650 is an electric vehicle that also includes a solar panel 654. As shown in FIG. 6B, the first vehicle 650 is parked in parking space 608 and is coupled to the electric vehicle charge point 636. The second vehicle 652 is another electric vehicle that does not include a solar panel. As shown in FIG. 6B, the second vehicle 652 is parked in parking space 614 and is coupled to the electric vehicle charge point 642. In this scenario, there are no shadows detected over any of the parking spaces 604-614.

In one example, a system (e.g., data analysis system 103 of FIG. 1, system 100 of FIG. 1) could be configured to receive the charging capability information of vehicles 650 and 652. The system could also be configured to receive information corresponding to the charging profiles of vehicles 650 and 652. The system could also be configured to determine the charge point data for all of the electric vehicle charge points 632-636. The system could also be configured to determine structural information (e.g., one or more physical dimensions, geographic locations, etc.) of the parking lot 602 and the building 646 based on map object data and point of interest data corresponding to the example environment 600. Continuing with this example, the system could be configured to generate a recommendation for an optimal charge position within the parking lot 602 for each of the vehicles 650 and 652. In one embodiment, the generated recommendation could be based on the charging capability information of vehicles 650 and 652, the charging profiles of vehicles 650 and 652, the determined charge point data for all of the electric vehicle charge points 632-636, and the determined structural information of the parking lot 602 and the building 646.

As shown, FIG. 6C corresponds to the top-view of the example environment 600 of FIG. 6A. In a second scenario, the example environment 600 in FIG. 6C includes the first vehicle 650 and the second vehicle 652 in the same positions as shown in FIG. 6B. However, in this scenario, there is a shadow 656 that is covering parking spaces 608 and 614.

In one example, a system (e.g., data analysis system 103 of FIG. 1, system 100 of FIG. 1) could be configured to receive information corresponding to the hardware charging capabilities of vehicles 650 and 652. The system could also be configured to receive information corresponding to the vehicle charging profiles of vehicles 650 and 652. The system could also be configured to analyze the electric vehicle charge point data for all of the electric vehicle charge points 632-636. The system could also be configured to determine one or more electric vehicle charging spaces associated with a minimum level of direct exposure to the sun. In this example, the system could determine that only the parking spaces 604, 606, 610, and 612 meet a minimum level of direct exposure to the sun. Continuing with this example, the system could be configured to generate a recommendation for an optimal charge position within the parking lot 602 for each of the vehicles 650 and 652. In one embodiment, the generated recommendation could be based on the hardware charging capabilities of vehicles 650 and 652, the vehicle charging profiles of vehicles 650 and 652, the determined electric vehicle charge point data for all of the electric vehicle charge points 632-636, and the determined one or more electric vehicle charging spaces (604, 606, 610, 612) associated with a minimum level of direct exposure to the Sun. Continuing with this embodiment, the system could be configured to provide one or more instructions for either of the vehicles 650 and 652 to park at an optimal electric vehicle charge space.

In the scenario shown in FIG. 6C, the system could determine that vehicle 650 is better suited to park at one of the parking spaces 604, 606, 610, and 612. The system could provide instructions for the vehicle 650 to be moved from the parking space 608 to any of the parking spaces 604, 606, 610, and 612 based on availability and compatibility with the corresponding electric vehicle charge points. Repositioning the vehicle 650 to any of the parking spaces 604, 606, 610, and 612 could enable the vehicle 650 to utilize the solar panel 654 for charging the battery of the vehicle 650 based on the direct exposure to the Sun.

As shown, FIG. 6D corresponds to the top-view of the example environment 600 of FIG. 6A. In a third scenario, the example environment 600 in FIG. 6D includes the first vehicle 650 and the second vehicle 652 in the same positions as shown in FIG. 6B. However, in this scenario, there is a shadow 658 that is covering all of parking spaces 608 and 614 and a portion of parking spaces 606 and 612.

In one example, a system (e.g., data analysis system 103 of FIG. 1, system 100 of FIG. 1) could be configured to receive parking data corresponding to the parking lot 602. The system could also be configured to analyze the parking spaces 604-614. The system could also be configured to determine a charging score corresponding to each of the parking spaces 604-614 based on the analysis of the parking data. Based on the determined charging score corresponding to each of the parking spaces 604-614, the system could also be configured to generate an output signal for moving one of the vehicles 650 and 652 from a first parking space to a second parking space.

In the scenario shown in FIG. 6D, the system could determine a charging score of 0 for parking spaces 608 and 614, a charging score of 50 for parking spaces 606 and 612, and a charging score of 100 for parking spaces 604 and 610. In this scenario, the system could determine that vehicle 650 is better suited to park at one of the parking spaces 604 and 610. The system could provide an output signal for the vehicle 650 to be moved from the parking space 608 to either of the parking spaces 604 and 610 based on availability and compatibility with the corresponding electric vehicle charge points. Repositioning the vehicle 650 to either of the parking spaces 604, and 610 could enable the vehicle 650 to utilize the solar panel 654 for charging the battery of the vehicle 650 based on the direct exposure to the Sun.

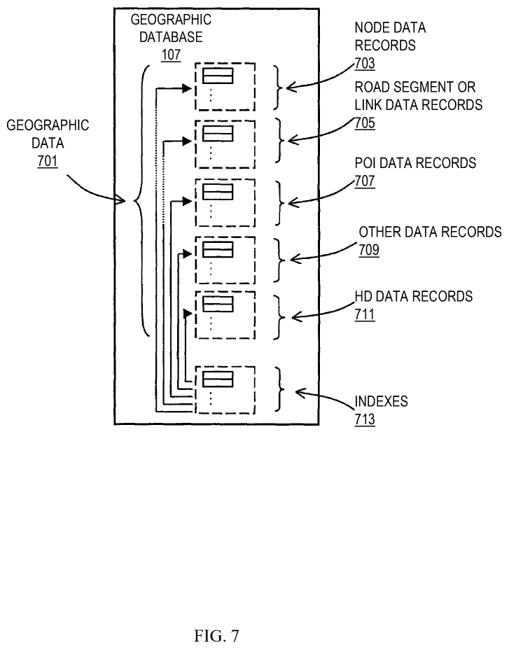

FIG. 7 is a diagram of the geographic database 107 of system 100, according to exemplary embodiments. In the exemplary embodiments, the information generated by the map platform 101 can be stored, associated with, and/or linked to the geographic database 107 or data thereof. In one embodiment, the geographic database 107 includes geographic data 701 used for (or configured to be compiled to be used for) mapping and/or navigation-related services, such as for personalized route determination, according to exemplary embodiments. For example, the geographic database 107 includes node data records 703, road segment data records 705, POI data records 707, other data records 709, high-definition (HD) data records 711, and indexes 713, for example. It is envisioned that more, fewer or different data records can be provided.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions, models, routes, etc. Accordingly, the terms polygons and polygon extrusions/models as used herein can be used interchangeably.

In one embodiment, the following terminology applies to the representation of geographic features in the geographic database 107.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 107 follows certain conventions. For example, links do not cross themselves and do not cross each other except at a node or vertex. Also, there are no duplicated shape points, nodes, or links. Two links that connect each other have a common node or vertex. In the geographic database 107, overlapping geographic features are represented by overlapping polygons. When polygons overlap, the boundary of one polygon crosses the boundary of the other polygon. In the geographic database 107, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

In one embodiment, the geographic database 107 is presented according to a hierarchical or multi-level tile projection. More specifically, in one embodiment, the geographic database 107 may be defined according to a normalized Mercator projection. Other projections may be used. In one embodiment, a map tile grid of a Mercator or similar projection can a multilevel grid. Each cell or tile in a level of the map tile grid is divisible into the same number of tiles of that same level of grid. In other words, the initial level of the map tile grid (e.g., a level at the lowest zoom level) is divisible into four cells or rectangles. Each of those cells are in turn divisible into four cells, and so on until the highest zoom level of the projection is reached.

In one embodiment, the map tile grid may be numbered in a systematic fashion to define a tile identifier (tile ID). For example, the top left tile may be numbered 00, the top right tile may be numbered 01, the bottom left tile may be numbered 10, and the bottom right tile may be numbered 11. In one embodiment, each cell is divided into four rectangles and numbered by concatenating the parent tile ID and the new tile position. A variety of numbering schemes also is possible. Any number of levels with increasingly smaller geographic areas may represent the map tile grid. Any level (n) of the map tile grid has 2(n+1) cells. Accordingly, any tile of the level (n) has a geographic area of A/2(n+1) where A is the total geographic area of the world or the total area of the map tile grids. Because of the numbering system, the exact position of any tile in any level of the map tile grid or projection may be uniquely determined from the tile ID.

In one embodiment, the system 100 may identify a tile by a quadkey determined based on the tile ID of a tile of the map tile grid. The quadkey, for example, is a one-dimensional array including numerical values. In one embodiment, the quadkey may be calculated or determined by interleaving the bits of the row and column coordinates of a tile in the grid at a specific level. The interleaved bits may be converted to a predetermined base number (e.g., base 10, base 4, hexadecimal). In one example, leading zeroes are inserted or retained regardless of the level of the map tile grid in order to maintain a constant length for the one-dimensional array of the quadkey. In another example, the length of the one-dimensional array of the quadkey may indicate the corresponding level within the map tile grid. In one embodiment, the quadkey is an example of the hash or encoding scheme of the respective geographical coordinates of a geographical data point that can be used to identify a tile in which the geographical data point is located.

In exemplary embodiments, the road segment data records 705 are links or segments representing roads, streets, or paths, as can be used in the calculated route or recorded route information for determination of one or more personalized routes, according to exemplary embodiments. The node data records 703 are end points or vertices (such as intersections) corresponding to the respective links or segments of the road segment data records 705. The road segment data records 705 and the node data records 703 represent a road network, such as used by vehicles, cars, and/or other entities. Alternatively, the geographic database 107 can contain path segment and node data records or other data that represent pedestrian paths or areas in addition to or instead of the vehicle road record data, for example. In one embodiment, the road or path segments can include an altitude component to extend to paths or road into three-dimensional space (e.g., to cover changes in altitude and contours of different map features, and/or to cover paths traversing a three-dimensional airspace).

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 107 can include data about the POIs and their respective locations in the POI data records 707. In one example, the POI data records 707 may include the hours of operation for various businesses. The geographic database 107 can also include data about places, such as cities, towns, or other communities, and other geographic features, such as bodies of water, mountain ranges, etc. Such place or feature data can be part of the POI data records 707 or can be associated with POIs or POI data records 307 (such as a data point used for displaying or representing a position of a city).

In one embodiment, other data records 709 include cartographic (“carto”) data records, weather data, traffic data, routing data, and maneuver data. In one example, the other data records 709 include data that is associated with certain POIs, roads, or geographic areas. In one example, the data is stored for utilization by a third-party. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using the point-based map matching embodiments describes herein), for example.

In one example, the other data records 709 include weather data records such as weather data reports. In this example, the weather data records can be associated with any of the map features stored in the geographic database 107 (e.g., a specific road or link, node, intersection, area, POI, etc.) on which the weather data was collected. In another example, the other data records 709 include traffic data records such as traffic data reports. In this example, the traffic data records can be associated with any of the map features stored in the geographic database 107 (e.g., a specific road or link, node, intersection, area, POI, etc.) on which the traffic data was collected.

In one embodiment, the other data records 709 include electric vehicle charging point data records. For example, the electric vehicle charging point data records can be associated with any of the map features stored in the geographic database 107 (e.g., a specific road or link, node, intersection, area, POI, etc.) on which data was collected. In one example, the electric vehicle charging point data records includes spatial and temporal elements that correspond to one or more map features stored in the geographic database 107. In another example, the electric vehicle charging point data records includes one or more recommended activities of an occupant of a vehicle.

In one embodiment, the geographic database 107 may also include point data records for storing the point data, map features, as well as other related data used according to the various embodiments described herein. In addition, the point data records can also store ground truth training and evaluation data, machine learning models, annotated observations, and/or any other data. By way of example, the point data records can be associated with one or more of the node data records 703, road segment data records 705, and/or POI data records 707 to support verification, localization or visual odometry based on the features stored therein and the corresponding estimated quality of the features. In this way, the point data records can also be associated with or used to classify the characteristics or metadata of the corresponding records 703, 705, and/or 707.

As discussed above, the HD data records 711 may include models of road surfaces and other map features to centimeter-level or better accuracy. The HD data records 711 may also include models that provide the precise lane geometry with lane boundaries, as well as rich attributes of the lane models. These rich attributes may include, but are not limited to, lane traversal information, lane types, lane marking types, lane level speed limit information, and/or the like. In one embodiment, the HD data records 711 may be divided into spatial partitions of varying sizes to provide HD mapping data to vehicles and other end user devices with near real-time speed without overloading the available resources of these vehicles and devices (e.g., computational, memory, bandwidth, etc. resources). In some implementations, the HD data records 711 may be created from high-resolution 3D mesh or point-cloud data generated, for instance, from LiDAR-equipped vehicles. The 3D mesh or point-cloud data may be processed to create 3D representations of a street or geographic environment at centimeter-level accuracy for storage in the HD data records 711.

In one embodiment, the HD data records 711 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

The indexes 713 in FIG. 7 may be used improve the speed of data retrieval operations in the geographic database 107. Specifically, the indexes 713 may be used to quickly locate data without having to search every row in the geographic database 107 every time it is accessed. For example, in one embodiment, the indexes 713 can be a spatial index of the polygon points associated with stored feature polygons.

The geographic database 107 can be maintained by the one or more content providers 111a-111n in association with the services platform 113 (e.g., a map developer). The map developer can collect geographic data to generate and enhance the geographic database 107. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 107 can be a master geographic database stored in a format that facilitates updating, maintenance, and development. For example, the master geographic database 107 or data in the master geographic database 107 can be in an Oracle spatial format or other spatial format (for example, accommodating different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for electric vehicle organization may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

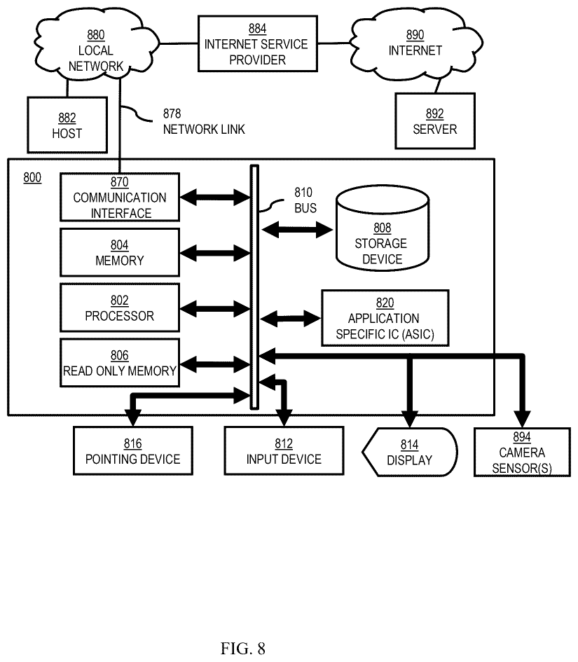

FIG. 8 illustrates a computer system 800 upon which an embodiment may be implemented. Computer system 800 is programmed (e.g., via computer program code or instructions) to provide information for electric vehicle organization as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to electric vehicle organization. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random-access memory (RAM) or other dynamic storage device, stores information including processor instructions for electric vehicle organization. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for electric vehicle organization, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in the computer system 800. Other external devices coupled to bus 810, used primarily for interacting with humans, include a display 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

The computer system 800 may also include one or more instances of a communications interface 870 coupled to bus 810. The communication interface 870 may provide a one-way or two-way communication coupling to a variety of external devices that operate with their own processors, such as printers, scanners and external disks. In addition, the communication interface 870 may provide a coupling to a local network 880, by way of a network link 878. The local network 880 may provide access to a variety of external devices and systems, each having their own processors and other hardware. For example, the local network 880 may provide access to a host 882, or an internet service provider 884, or both, as shown in FIG. 8. The internet service provider 884 may then provide access to the Internet 890, in communication with various other servers 892.

The computer system 800 also includes one or more instances of a communication interface 870 coupled to bus 810. Communication interface 870 provides a one-way or two-way communication coupling to a variety of external devices that operate with their own processors, such as printers, scanners and external disks. In general, the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, the communication interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, the communication interface 870 may be a local area network (LAN) card to provide a data communication connection to a compatible LAN, such as Ethernet. Wireless links may also be implemented. For wireless links, the communication interface 870 sends or receives or both sends and receives electrical, acoustic or electromagnetic signals, including infrared and optical signals, that carry information streams, such as digital data. For example, in wireless handheld devices, such as mobile telephones like cell phones, the communication interface 870 includes a radio band electromagnetic transmitter and receiver called a radio transceiver. In certain embodiments, the communication interface 870 enables connection to the communication network 115 of FIG. 1 for providing information for electric vehicle organization.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

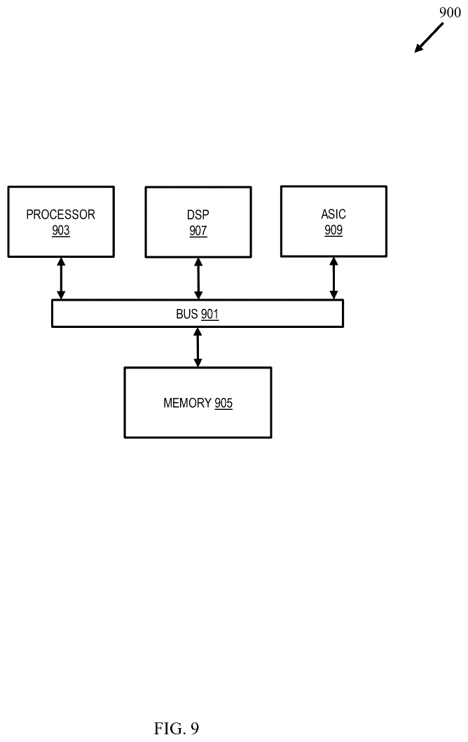

FIG. 9 illustrates a chip set 900 upon which an embodiment may be implemented. The chip set 900 is programmed for electric vehicle organization as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively, or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the steps described herein to provide information for electric vehicle organization. The memory 905 also stores the data associated with or generated by the execution of the inventive steps.

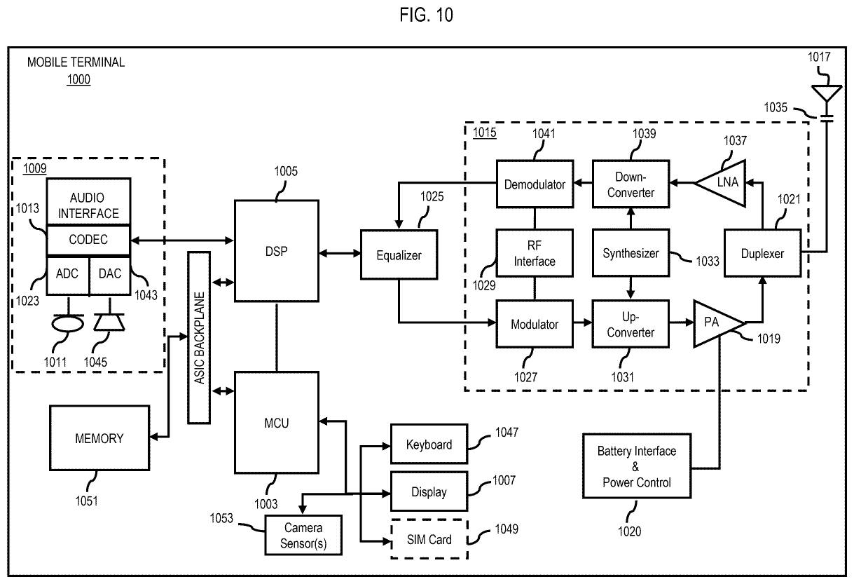

FIG. 10 is a diagram of exemplary components of a mobile terminal 1000 (e.g., a mobile device, vehicle, and/or part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions that offer automatic contact matching. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G networks, code division multiple access (CDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a landline connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile station 1001 to provide information for electric vehicle organization. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1051 may be, but not limited to, a single memory, CD, DVD, ROM, RAM, EEPROM, optical storage, or any other non-volatile or non-transitory storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The SIM card 149 also contains a memory for storing a personal telephone number registry, text messages, and user specific mobile station settings.

While features have been described in connection with a number of embodiments and implementations, various obvious modifications and equivalent arrangements, which fall within the purview of the appended claims are envisioned. Although features are expressed in certain combinations among the claims, it is contemplated that these features can be arranged in any combination and order.

We (I) claim:

1. A method comprising:
receiving charging capability information of one or more vehicles, wherein the charging capability information includes at least electric vehicle charge point requirements of the one or more vehicles and solar panel information of the one or more vehicles;
receiving information corresponding to charging profiles of the one or more vehicles;
determining charge point data in a given area associated with the one or more vehicles;
determining map object data and point of interest data in the given area; and
generating a recommendation for an optimal charge position within the given area for a vehicle of the one or more vehicles based on a charging capability information of the vehicle, a charge profile of the vehicle, the determined charge point data in the given area, and the determined map object data and the point of interest data.

2. The method of claim 1, further comprising:
analyzing weather data corresponding to the given area associated with the one or more vehicles; and
generating the recommendation for the optimal charge position within the given area for the vehicle of the one or more vehicles based on the charging capability information of the vehicle, the charge profile of the vehicle, the determined charge point data in the given area, the determined map object data and the point of interest data, and the weather data corresponding to the given area.

3. The method of claim 2, wherein the vehicle is an autonomous vehicle, wherein generating a recommendation for the optimal charge position includes providing an autonomous vehicle control signal to the vehicle that enables the vehicle to move from a first position to the optimal charge position.

4. The method of claim 1, further comprising:
receiving a request to charge a battery of a parked vehicle of the one or more vehicles;
determining a preferred charge level associated with the parked vehicle; and
based on the preferred charge level, generating a recommendation for moving the parked vehicle to a charge position for charging the parked vehicle via a solar panel of the parked vehicle.

5. The method of claim 1, further comprising:
analyzing expected usage data corresponding to a parked vehicle of the one or more vehicles; and
generating the recommendation for the optimal charge position within the given area for the vehicle of the one or more vehicles based on the charging capability of the vehicle, the charge profile of the vehicle, the determined charge point data in the give area, the determined map object data and the point of interest data, and the usage data corresponding to the parked vehicle.

6. The method of claim 1, wherein the vehicle is equipped with at least one solar panel, wherein determining the map object data and point of interest data in the given area includes:
determining one or more expected shadows in one or more charge positions based on the map object data the point of interest data; and
determining an expected amount of charge available to the vehicle via the at least one solar panel based on an analysis of the determined one or more expected shadows in one or more charge positions.

7. The method of claim 1, wherein generating the recommendation for the optimal charge position within the given area further includes a recommended interval of time for charging the vehicle of the one or more vehicles via a solar panel of the vehicle.

8. The method of claim 1, further comprising:
providing a signal to a mobile apparatus that is configured to move the vehicle from a first position to the optimal charge position.

9. A non-transitory computer-readable storage medium carrying one or more sequences of one or more instructions which, when executed by one or more processors, cause an apparatus to perform the following steps:
receiving information corresponding to hardware charging capabilities of a vehicle;
receiving information corresponding to a vehicle charging profile of the vehicle;
analyzing electric vehicle charge point data in a given area associated with the vehicle;
determining one or more electric vehicle charging spaces associated with a minimum level of direct exposure to the Sun based on an analysis of at least one of map object data and point of interest data in the given area;
generating a recommendation for an optimal electric vehicle charging space of the one or more electric vehicle charging spaces based on an analysis of at least one or more of the hardware charging capabilities of the vehicle, the charge profile of the vehicle, the electric vehicle charge point data, and the determined one or more electric vehicle charging spaces associated with a minimum level of direct exposure to the Sun; and
providing one or more instructions for the vehicle to park at the optimal electric vehicle charging space.

10. The non-transitory computer-readable storage medium of claim 9, wherein the hardware charging capabilities includes information corresponding to the electric vehicle charge point requirements of the vehicle and information corresponding to at least one solar panel coupled to the vehicle.

11. The non-transitory computer-readable storage medium of claim 9, wherein generating the recommendation for an optimal electric vehicle charging space of the one or more electric vehicle charging spaces based on the analysis further includes:
determining an expected usage of the vehicle; and
generating the recommendation for the optimal electric vehicle charging space of the one or more electric vehicle charging spaces based on an analysis of at least one or more of the hardware charging capabilities of the vehicle, the charge profile of the vehicle, the electric vehicle charge point data, the determined one or more electric vehicle charging spaces associated with a minimum level of direct exposure to the Sun, and the expected usage of the vehicle.

12. The non-transitory computer-readable storage medium of claim 9, wherein generating the recommendation for an optimal electric vehicle charging space of the one or more electric vehicle charging spaces based on the analysis further includes:
determining one or more charging spaces of the one or more electric vehicle charging spaces that satisfy an expected charge based on analysis of indirect sunlight corresponding to the charging space; and
generating the recommendation for the optimal electric vehicle charging space of the one or more electric vehicle charging spaces based on an analysis of at least one or more of the hardware charging capabilities of the vehicle, the charge profile of the vehicle, the electric vehicle charge point data, the determined one or more electric vehicle charging spaces associated with a minimum level of direct exposure to the Sun, and the determined one or more charging spaces.

13. The non-transitory computer-readable storage medium of claim 9, wherein generating the recommendation for an optimal electric vehicle charging space of the one or more electric vehicle charging spaces based on the analysis further includes:
analyzing one or more images that include an aerial view of the one more electric vehicle charging spaces;
based on the analysis, determining a score associated with each of the one or more electric vehicle charging spaces; and
generating the recommendation for the optimal electric vehicle charging space of the one or more electric vehicle charging spaces based on an analysis of at least one or more of the hardware charging capabilities of the vehicle, the charge profile of the vehicle, the electric vehicle charge point data, the determined one or more electric vehicle charging spaces associated with a minimum level of direct exposure to the Sun, and the determined score associated with each of the one or more electric vehicle charging spaces.

14. The non-transitory computer-readable storage medium of claim 9, wherein generating the recommendation for an optimal electric vehicle charging space of the one or more electric vehicle charging spaces based on the analysis further includes:
analyzing weather data corresponding to the given area associated with the one or more vehicles; and
generating the recommendation for the optimal electric vehicle charging space of the one or more electric vehicle charging spaces based on an analysis of at least one or more of the hardware charging capabilities of the vehicle, the charge profile of the vehicle, the electric vehicle charge point data, the determined one or more electric vehicle charging spaces associated with a minimum level of direct exposure to the Sun, and the weather data corresponding to the given area.

15. A method comprising:
receiving parking data corresponding to one or more areas for parking vehicles;
analyzing one or more parking spaces of the one or more areas;
determining a charging score corresponding to each of the one or more parking spaces based on an analysis of the parking data; and
based on the determined charging score corresponding to each of the one or more parking spaces, generating an output signal for moving a vehicle from a first parking space of the one or more parking spaces to a second parking space of the one or more parking spaces.

16. The method of claim 15, wherein the one or more areas for parking vehicles are part of a parking structure, wherein the parking structure includes a plurality of levels of parking.

17. The method of claim 16, wherein analyzing the one or more parking spaces of the one or more areas includes an analysis of the amount of direct and indirect sunlight associated with the one or more parking spaces.

18. The method of claim 16, further comprising:
analyzing weather data corresponding to the parking structure; and
determining the charging score corresponding to each of the one or more parking spaces based on an analysis of the parking data and the weather data.

19. The method of claim 15, wherein the vehicle is an autonomous vehicle, wherein generating the output signal for moving the vehicle from the first parking space of the one or more parking spaces to the second parking space of the one or more parking spaces causes the vehicle to operate autonomously and reposition the vehicle from the first parking space to the second parking space.

20. The method of claim 15, wherein generating the output signal for moving the vehicle from the first parking space of the one or more parking spaces to the second parking space of the one or more parking spaces causes a mobile apparatus to move the vehicle from the first parking space to the second parking space.
